(19) United States
(12) Patent Application Publication
(10) Pub. No.: US 2025/0165664 A1
(43) Pub. Date: May 22, 2025

(54) ANALYTICAL METHOD FOR DYNAMIC ANALYSIS OF NATURAL GAS NETWORK

(71) Applicant: SOUTHEAST UNIVERSITY, Nanjing (CN)

(72) Inventors: Suhan Zhang, Nanjing, Jiangsu (CN); Wei Gu, Nanjing, Jiangsu (CN); Shuai Lu, Nanjing, Jiangsu (CN)

(21) Appl. No.: 19/026,349

(22) Filed: Jan. 16, 2025

Related U.S. Application Data
(63) Continuation of application No. PCT/CN2024/081591, filed on Mar. 14, 2024.

(30) Foreign Application Priority Data
Nov. 3, 2023 (CN) 202311454335.6

(51) Int. Cl. G06F 30/18; G06F 111/10

(52) U.S. Cl. CPC G06F 30/18; G06F 2111/10

(57) ABSTRACT

Disclosed is an analytical method for dynamic analysis of a natural gas network in the field of energy system modeling and operational analysis, which includes establishing adynamic model of natural gas transmission according to the conservation equations, and reconstructing the dynamic model into the equations in a heat conduction equation form. The present disclosure directly constructs an analytical method for dynamic analysis of a natural gas network, avoiding approximation errors, numerical dispersion, and dissipation compared with the traditional numerical methods. The discretization process is avoided during the solution, greatly improving the computational efficiency and solution accuracy of dynamic analysis of the natural gas network.

### CROSS-REFERENCE TO RELATED APPLICATIONS

This application is a continuation of PCT/CN2024/081591, filed on Mar. 14, 2024 and claims priority of Chinese Patent Application No. 202311454335.6, filed on Nov. 3, 2023, the entire contents of which are incorporated herein by reference.

### TECHNICAL FIELD

The present disclosure relates to the field of energy system modeling and operational analysis, and in particular to an analytical method for dynamic analysis of a natural gas network.

### BACKGROUND

The growing energy consumption and environmental pressures are driving the transformation of low-carbon green energy network technologies. Cities, as the main subjects of energy consumption and transformation, are transitioning towards complex energy networks with multiple energy flows and dynamics. As an important component of the urban energy network, a natural gas system can significantly improve the overall utilization efficiency of energy system and enhance the renewable consumption through the integration with the power system and heating system, as well as through optimized energy management. The time scales for the operation and management of different energy networks vary significantly, making it necessary to obtain real-time, reliable, and consistent network information based on accurate simulation models and technologies. However, since multi-energy networks are managed and operated by different companies, the exchange of information is highly limited, requiring special attention to information protection during co-simulation and operational optimization.

The simulation of the natural gas system essentially involves defining a set of state variables to describe the key characteristics of the system, followed by mechanism analysis to acquire the evolution of all state variables under a given boundary. Since the natural gas system model is composed of a set of partial differential-algebraic equations, one of the mainstream methods is to discretize the pipeline model using space-time segmentation and recursively calculate the state distribution within the system based on boundary and initial conditions. However, to ensure calculation efficiency, a large number of segments is typically required for each pipeline, which results in a low computational efficiency for the recursive process. Additionally, it is difficult to directly and quantitatively characterize the response of the state variables in the natural gas system to external boundaries.

In light of the above shortcomings, it is necessary to develop an analytical model for the transmission dynamics of the natural gas system that balances both accuracy and complexity from a modeling perspective. This model would allow for the rapid and precise description of the system's dynamic processes, making it more conducive to multi-agent simulation and optimization operation, and better suited to the practical application conditions in engineering.

### SUMMARY

In view of the deficiencies of the prior art, the present disclosure proposes an analytical method for dynamic analysis of a natural gas network. The disclosure utilizes a constant variation method to derive an equivalent form of a dynamic transmission model of a natural gas system. Furthermore, based on the superposition, time-invariant, and causal properties of natural gas transmission, practical analytical forms of the dynamic model under different initial conditions and boundary conditions, as well as the equivalent network model, are constructed, providing a modeling basis for the operational analysis of an integrated energy system.

An object of the present disclosure may be achieved by the following technical solutions:

An analytical method for dynamic analysis of a natural gas network is provided, including:
establishing a dynamic model of natural gas transmission according to the conservation equations, and reconstructing the dynamic model into the equations in a heat conduction equation form;
transforming the heat conduction equation into a partial differential equation set with homogeneous boundary conditions using a method of variation of parameters, and constructing a general analytical expression for the partial differential equation set under constant pressure boundaries;
constructing, based on superposition principle, practical analytical expressions for the dynamic model of natural gas transmission;
constructing, according to system topologies and time-invariant, and causal properties of a natural gas system, a natural gas network equivalent model based on the practical analytical expressions; and
determining pressures at load nodes and mass flows at source nodes based on the natural gas network equivalent model.

In some embodiments, the establishing a dynamic model of natural gas transmission according to the conservation equations includes the following steps:
establishing a dynamic model of natural gas transmission in a pipeline, including a mass conservation equation and a momentum conservation equation as below:

$$\frac{\partial {p}_{x , t}}{\partial t} + \frac{{c}^{2}}{S} \frac{\partial {q}_{x , t}}{\partial x} = 0 , \frac{\partial {p}_{x , t}}{\partial x} + \frac{λ {wq}_{x , t}}{2 SD} = 0 , \qquad ( 1 )$$

where x and t represent space and time, respectively, and c represents a speed of sound, taken as 340 m/s; p_{x,t} represents a pressure of natural gas, Pa; q_{x,t} represents mass flow of natural gas, kg/s; w represents an average velocity of natural gas, m/s; D represents an inner diameter of the pipeline, m; S represents a cross-sectional area of the pipeline, m²; and λ represents a resistance coefficient of the pipeline; and
setting initial conditions and boundary conditions in the dynamic analysis of the natural gas system as follows:

$${p}_{x , 0} = {φ}_{p , x} , {q}_{x , 0} = {φ}_{q , x} , {p}_{0 , t} , {q}_{L , t} , \qquad ( 2 )$$

where p_{x,0} and q_{x,0} represent distributions of pressure and mass flow in the pipeline at moment 0 respectively, namely, the initial conditions; φ_{p,x} and φ_{q,x} represent initial condition functions of pressure and mass flow, respectively; L represents a length of the pipeline, m; p_{0,t} represents a time-series of pressure at an inlet of the pipeline, namely, pressure boundary; and q_{L,t} represents a time-series of mass flow at an outlet of the pipeline, namely, flow boundary.

In some embodiments, the reconstructing the dynamic gas flow model into the equations in a heat conduction equation form includes the following steps:

deriving a partial derivative for x from a second equation in Eq. before substituting into a first equation in Eq. (1) to obtain a heat conduction form equation as follows:

$$\frac{\partial {q}_{x , t}}{\partial x} = \frac{- 2 DS}{λ w} \frac{{\partial }^{2} {p}_{x , t}}{\partial {x}^{2}} ⇒ \{ \begin{matrix}\frac{\partial {p}_{x , t}}{\partial t} = α \frac{{\partial }^{2} {p}_{x , t}}{\partial {x}^{2}} \\ α = \frac{2 {Dc}^{2}}{λ w}\end{matrix} , \qquad ( 3 )$$

where α represents a coefficient term in the heat conduction form equation; accordingly, the partial derivative of pipeline outlet pressure for x can be obtained through the following equation and is defined as mₜ.

$$\frac{\partial p}{\partial x} {\vert}_{x = L} = - \frac{λ w}{2 DS} {q}_{L , ι} = {m}_{ι} , \qquad ( 4 )$$

Eq. (1) is converted to:

$$\{ \begin{matrix}\frac{\partial {p}_{x , t}}{\partial t} = α \frac{{\partial }^{2} {p}_{x , t}}{\partial {x}^{2}} , \frac{\partial {p}_{x , t}}{\partial x} {\vert}_{x = L} = {m}_{t} \\ p ( 0 , t ) = {p}_{0 , t} , p ( x , 0 ) = {φ}_{p , x}\end{matrix} . \qquad ( 5 )$$

In some embodiments, the transforming the heat conduction equation into a partial differential equation set with homogeneous boundary conditions using a method of variation of parameters includes the following steps:
taking p_{0,t} as constant with the value of ψ_{p,1}, introducing an intermediate variable u_{x,t} and reconstructing p_{x,t} as follows:

$${p}_{x , t} = {u}_{x , t} + x ( \frac{\partial p}{\partial x} {\vert}_{x = L} ) + {p}_{0 , t} ; \qquad ( 6 )$$

substituting x=0 and t=0 into Eq. (6) to obtain initial conditions and a set of boundary conditions for u_{x,t}, respectively:

$$\begin{matrix} & \{ \begin{matrix}{u}_{x , 0} = {p}_{x , 0} − {x ( {\frac{\partial p}{\partial x} \vert}_{x = L} ) \vert}_{t = 0} − {p}_{0 , 0} \\ {p}_{0 , t} = {u}_{0 , t} + {p}_{0 , t} ⇒ {u}_{0 , t} = 0\end{matrix}\end{matrix} ; \qquad ( 7 )$$

deriving a partial derivative for x on both sides of Eq. (6) at x=L to obtain a further set of boundary conditions for u_{x,t}, expressed as follows:

$${\frac{\partial {p}_{x , t}}{\partial x} = \frac{\partial {u}_{x , t}}{\partial x} + {\frac{\partial {p}_{x , t}}{\partial x} \vert}_{x = L} ⇒ \frac{\partial {u}_{x , t}}{\partial x} \vert}_{x = L} = 0 ; \qquad ( 8 )$$

deriving a second-order partial derivative for x and a first-order partial derivative for t on both sides of Eq. (6), respectively:

$${\frac{{\partial }^{2} {p}_{x , t}}{\partial {x}^{2}} = \frac{{\partial }^{2} {p}_{x , t}}{\partial {x}^{2}} + \frac{\partial {p}_{x , t}}{\partial t} = \frac{\partial {u}_{x , t}}{\partial t} + x \frac{\partial }{\partial t} ( \frac{\partial {p}_{x , t}}{\partial x} \vert}_{x = L} ) ; \qquad ( 9 )$$

and
substituting Eq. (9) into Eq. (5), with Eq. (5) re-expressing a partial differential equation set with homogeneous boundary conditions as follows:

$$\{ \begin{matrix}\frac{\partial {u}_{x , t}}{\partial t} = α \frac{{\partial }^{2} {u}_{x , t}}{\partial {x}^{2}} + {f}_{x , t} \\ {{{u}_{x , 0} = {p}_{x , 0} − x ( \frac{\partial p}{\partial x} \vert}_{x = L} ) \vert}_{t = 0} − {p}_{0 , 0} \frac{\partial {u}_{x , t}}{\partial x} {\vert}_{x = L} = 0. \\ {u}_{0 , t} = 0 , {f}_{x , t} = − x \frac{\partial }{\partial t} ( {\frac{\partial p}{\partial x} \vert}_{x = L} ) = − x \frac{\partial {m}_{t}}{\partial t}\end{matrix} \qquad ( 10 )$$

In some embodiments, the constructing a general analytical expression for the partial differential equation set under constant pressure boundaries includes the following steps:
defining u_{x,t}* as a solution of a homogeneous problem of Eq. (10), and solving the homogeneous problem as follows:

$${u}_{x , t}^{*} = {T}_{0} ( t ) {\sum }_{n = 1}^{∞} {k}_{2} sin \frac{( 2 n - 1 ) π x}{2 L} , \qquad ( 11 )$$

where k₂ represents a coefficient term; T₀(t) represents a function component about time in u_{x,t}*; n represents the number of Fourier components; analogy to the form of u_{x,t}*, a form of u_{x,t} in Eq. (10) is assumed as follows:

$${u}_{x , t} = {\sum }_{n = 1}^{∞} {u}_{n , t} sin \frac{( 2 n - 1 ) π x}{2 L} , \qquad ( 12 )$$

where u_{n,t} represents a function component about time in u_{x,t}; f_{x,t} in Eq. (10) is expanded according to a base in Eq. (11):

$${f}_{x , t} = {\sum }_{n = 1}^{∞} {f}_{n , t} sin \frac{( 2 n - 1 ) π x}{2 L} , \qquad ( 13 )$$

$${f}_{n , t} = \frac{2}{L} {\int }_{0}^{L} {f}_{x , t} sin \frac{( 2 n - 1 ) π x}{2 L} dx , \qquad ( 14 )$$

where f_{n,t} represents a function component about time in f_{x,t}, obtained by inverse Fourier transformation shown in Eq. (14); Eq. (12) to (14) are substituted into a first equation in Eq. (10):

$$\{ \begin{matrix}\frac{\partial {u}_{n , t}}{\partial t} + {g}_{n} {u}_{n , t} = {f}_{n , t} \\ {g}_{n} = \frac{{( 2 n − 1 )}^{2} {π}^{2} α}{4 {L}^{2}} \\ {u}_{n , 0} = \frac{2}{L} {\int }_{0}^{L} {u}_{x , 0} sin \frac{( 2 n − 1 ) π x}{2 L} dx\end{matrix} , \qquad ( 15 )$$

where gₙ represents a coefficient term in an n-th nonhomogeneous partial differential, u_{n,0} represents a value of u_{n,t} when t=0; Eq. (15) is solved to obtain analytical expressions for u_{n,t} and u_{x,t}, respectively as follows:

$${u}_{n , t} = {e}^{- {g}_{n} t} \{ {u}_{n , 0} + {\int }_{0}^{t} {f}_{n , τ} {e}^{{g}_{n} τ} d τ \} , \qquad ( 16 )$$

$${u}_{x , t} = {\sum }_{n = 1}^{∞} {e}^{- {g}_{n} t} \{ {u}_{n , 0} + {\int }_{0}^{t} {f}_{n , τ} {e}^{{g}_{n} τ} d τ \} sin \frac{( 2 n - 1 ) π x}{2 L} ; \qquad ( 17 )$$

substituting Eq. (17) into Eq. (6) to obtain an analytical expression for p_{x,t} at constant pressure:

$${p}_{x , t} = {\sum }_{n = 1}^{∞} {e}^{- {g}_{n} t} \{ {u}_{n , 0} + {\int }_{0}^{t} {f}_{n , τ} {e}^{{g}_{n} τ} d τ \} sin \frac{( 2 n - 1 ) π x}{2 L} - \frac{λ wx}{2 Ds} {q}_{L , t} + {p}_{0 , t} ; \qquad ( 18 )$$

substituting Eq. (18) into a second equation in Eq. (1) to obtain an analytical expression for q_{x,t} at constant pressure:

$${q}_{x , t} = - \frac{2 DS}{λ w} \frac{\partial {p}_{x , t}}{\partial x} = {q}_{L , t} + \{ {\sum }_{n = 1}^{∞} \frac{( 1 - 2 n ) π DS}{λ wL {e}^{{g}_{n} t}} \{ {u}_{n , 0} + {\int }_{0}^{t} {f}_{n , τ} {e}^{{g}_{n} τ} d τ \} cos \frac{( 2 n - 1 ) π x}{2 L} \} , \qquad ( 19 )$$

where p_{0,t} represents a constant pressure boundary; Eq. (18) and Eq. (19) are general analytical expressions for the partial differential equation set of the natural gas dynamic model under constant pressure boundaries.

In some embodiments, the constructing, based on superposition principle, practical analytical expressions for the dynamic model of natural gas transmission includes the following steps:
reconstructing the pressure boundary, expressed as follows:

$$\{ \begin{matrix}{ψ}_{p} = [ {ψ}_{p , 1} , {ψ}_{p , 2} , … , {ψ}_{p , Nt} ] \\ {ψ}_{p , i} = \{ \begin{matrix}{p}_{0 , i} & i = 1 \\ {p}_{0 , i} - {p}_{0 , i - 1} & i > 1\end{matrix} , {t}_{i} = i Δ t\end{matrix} , \qquad ( 20 )$$

where Nt represents a length of the boundary condition, and Δt is a time step; ψₚ represents a new boundary condition corresponding to a pressure increment, and an element ψ_{p,i} represents an increment of a pressure at moment tᵢ for a pressure at moment tᵢ₋₁;
decomposing, according to superposition principle of natural gas transmission, the pressures p_{x,t} as follows:

$${p}_{x , t} = {\sum }_{k = 1}^{i} {χ}_{k , x , t - {t}_{k - 1}} 1 \leq i \leq Nt , {t}_{k - 1} \leq t \leq {t}_{i} , \qquad ( 21 )$$

where each component χ_{k,x,t} satisfies:

$$\{ \begin{matrix}\frac{\partial {χ}_{k , x , t − {t}_{k − 1}}}{\partial t} = α \frac{{\partial }^{2} {χ}_{k , x , t − {t}_{k − 1}}}{\partial {x}^{2}} , \text{} t > {t}_{k − 1} , 0 < x < L \\ \frac{\partial {χ}_{k , x , t − {t}_{k − 1}}}{\partial t} {\vert}_{x = L} = \{ \begin{matrix}{m}_{t} & k = 1 \\ 0 & k > 1\end{matrix} , t > {t}_{k − 1} \\ {χ}_{k , x , t − {t}_{k − 1}} {\vert}_{x = 0} = \begin{matrix}{ψ}_{p , k} \text{} , & t > {t}_{k − 1}\end{matrix} \\ {χ}_{k , x , t − {t}_{k − 1}} {\vert}_{t = {t}_{k − 1}} = \{ \begin{matrix}{φ}_{p , x} & k = 1 , \\ 0 & k > 1\end{matrix} , \text{} 0 \leq x \leq L\end{matrix} , \qquad ( 22 )$$

when k=1, a form of χ_{k,x,t} is consistent with Eq. (18), namely:

$${χ}_{k , x , t - {t}_{k - 1}} = {\sum }_{n = 1}^{∞} {e}^{- {g}_{n} t} \{ {u}_{n , 0} + {\int }_{0}^{t} {f}_{n , τ} {e}^{{g}_{n} τ} d τ \} sin \frac{( 2 n - 1 ) π x}{2 L} \begin{matrix}+ {xm}_{t} + {ψ}_{p , 1} & k = 1 , t > {t}_{k - 1}\end{matrix} , \qquad ( 23 )$$

when k>1, a form of χ_{k,x,t} is as follows:

$${χ}_{k , x , t - {t}_{k - 1}} = {ψ}_{p , k} k > 1 , t > {t}_{k - 1} ; \qquad ( 24 )$$

calculating the initial conditions according to steady-state energy flow in practice, expressed as follows:

$${φ}_{p , x} = {K}_{1} x + {K}_{2} , {φ}_{q , x} = {K}_{3} , {m}_{0} = \frac{- λ w {φ}_{q , L}}{2 DS} , \qquad ( 25 )$$

where K₁, K₂, and K₃ represent constant coefficients in the initial conditions; m₀ represents a value of mₜ at t=0; and φ_{q,L} represents a value of the initial conditions of mass flow at x=L, namely, the mass flow at an outlet of the pipeline at t=0;
expressing mₜ as a segmented step function as follows:

$${m}_{t} = {\sum }_{i = 1}^{Nt} {m}_{i} ( {δ}_{t - {t}_{i}} - {δ}_{t - {t}_{i - 1}} ) t > 0 ; \qquad ( 26 )$$

substituting f_{x,t} in Eq. (10) and f_{n,t} in Eq. (14) into Eq. (16) as follows:

$$\begin{matrix}= {\int }_{0}^{t} ( \frac{- 2}{L} {\int }_{0}^{L} \times \frac{\partial {m}_{τ}}{\partial τ} sin \frac{( 2 n - 1 ) π x}{2 L} dx ) {e}^{{g}_{n}^{τ}} d τ \\ {\int }_{0}^{t} {f}_{n , π} {e}^{{g}_{n}^{τ}} d τ = \frac{- 2}{L} {\int }_{0}^{L} x sin \frac{( 2 n - 1 ) π x}{2 L} dx {\int }_{0}^{t} \frac{\partial {m}_{τ}}{\partial τ} {e}^{{g}_{n}^{τ}} d τ \\ = \frac{8 {L ( - 1 )}^{n}}{{( 2 n - 1 )}^{2} {π}^{2}} {\int }_{0}^{t} \frac{\partial {m}_{τ}}{\partial τ} {e}^{{g}_{n}^{τ}} d τ\end{matrix} ; \qquad ( 27 )$$

modifying an integral formula in Eq. (27) as follows:

$$\frac{\partial {m}_{τ}}{\partial τ} {e}^{{g}_{n} τ} = \frac{\partial ( {m}_{τ} {e}^{{g}_{n} τ} )}{\partial τ} - {g}_{n} {m}_{τ} {e}^{{g}_{n} τ} , \qquad ( 28 )$$

$${g}_{n} {\int }_{0}^{{t}_{k}} {m}_{τ} {e}^{{g}_{n} τ} d τ = {\sum }_{i = 1}^{k} {m}_{i} ( {e}^{{g}_{n} {t}_{i}} - {e}^{{g}_{n} {t}_{i - 1}} ) ; \qquad ( 29 )$$

substituting Eq. (28) and Eq. (29) into Eq. (27) as follows:

$$\frac{1}{{e}^{{g}_{n} {t}_{k}}} {\int }_{0}^{{t}_{k}} {f}_{n , τ} {e}^{{g}_{n} τ} d τ = - {E}_{1 n} ( {m}_{k} - \frac{{m}_{0}}{{e}^{{g}_{n} {t}_{k}}} - {\sum }_{i = 1}^{k} {m}_{i} \frac{{e}^{{g}_{n} Δ t} - 1}{{e}^{{g}_{n} ( {t}_{k} - {t}_{i - 1} )}} ) , \qquad ( 30 )$$

$${E}_{1 n} = \frac{8 {L ( - 1 )}^{n - 1}}{{( 2 n - 1 )}^{2} {π}^{2}} ; \qquad ( 31 )$$

and
substituting Eq. (30) into Eq. (18) and Eq. (19), to obtain the practical analytical expressions for the dynamic model of natural gas transmission as follows:

$${p}_{x , k} = {\sum }_{n = 1}^{∞} \{ \frac{{u}_{n , 0}}{{e}^{{g}_{n} {t}_{k}}} - {E}_{1 n} ( {m}_{k} - \frac{{m}_{0}}{{e}^{{g}_{n} {t}_{k}}} - {\sum }_{i = 1}^{k} {m}_{i} \frac{{e}^{{g}_{n} Δ t} - 1}{{e}^{{g}_{n} ( {t}_{k} - {t}_{i - 1} )}} ) \} sin \frac{( 2 n - 1 ) π x}{2 L} - \frac{λ wx}{2 DS} {q}_{L , k} + {p}_{0 , k} , \qquad ( 32 )$$

$${q}_{x , k} = {q}_{L , k} + \{ {\sum }_{n = 1}^{∞} \frac{( 1 - 2 n ) π DS}{λ wL} \{ \frac{{u}_{n , 0}}{{e}^{{g}_{n} {t}_{k}}} - {E}_{1 n} ( {m}_{k} - \frac{{m}_{0}}{{e}^{{g}_{n} {t}_{k}}} - {\sum }_{i = 1}^{k} {m}_{i} \frac{{e}^{{g}_{n} Δ t} - 1}{{e}^{{g}_{n} ( {t}_{k} - {t}_{i - 1} )}} ) \} cos \frac{( 2 n - 1 ) π x}{2 L} \} . \qquad ( 33 )$$

In some embodiments, the constructing, according to system topologies and time-invariant, and causal properties of a natural gas system, a natural gas network equivalent model based on the practical analytical expressions includes the following steps:
substituting x=L and x=0 into Eq. (32) and Eq. (33), respectively, to obtain pressure at the outlet and flow at the inlet of the pipeline at arbitrary tⱼ as follows:

$${p}_{L , j} = {\sum }_{n = 1}^{∞} {e}^{- {g}_{n} {t}_{j}} {{u}_{n , 0} ( - 1 )}^{n - 1} - \frac{λ wL}{2 DS} {q}_{L , j} + {p}_{0 , j} + {\sum }_{n = 1}^{∞} \frac{λ {wE}_{1 n}}{2 DS} {( - 1 )}^{n - 1} ( {q}_{L , j} - \frac{{q}_{L , 0}}{{e}^{{g}_{n} {t}_{j}}} - {\sum }_{i = 1}^{j} {q}_{L , i} \frac{{e}^{{g}_{n} Δ t} - 1}{{e}^{{g}_{n} ( j - i + 1 ) Δ t}} ) , \qquad ( 34 )$$

$${q}_{0 , j} = {q}_{L , j} + \frac{DS π}{λ wL} {\sum }_{n - 1}^{∞} ( 1 - 2 n ) {u}_{n , 0} {e}^{- {g}_{n} {t}_{j}} + \frac{π}{2 L} {\sum }_{n - 1}^{∞} ( 1 - 2 n ) {E}_{1 n} ( {q}_{L , j} - \frac{{q}_{L , 0}}{{e}^{{g}_{n} {t}_{j}}} - {\sum }_{i = 1}^{j} {q}_{L , i} \frac{{e}^{{g}_{n} Δ t} - 1}{{e}^{{g}_{n} ( j - i + 1 ) Δ t}} ) ; \qquad ( 35 )$$

reorganizing Eq. (34) and Eq. (35) as follows:

$$[ \begin{matrix}{p}_{L} \\ {q}_{0}\end{matrix} ] = [ \begin{matrix}{H}_{1} & {H}_{2} \\ {H}_{3} & {H}_{4}\end{matrix} ] [ \begin{matrix}{p}_{0} \\ {q}_{L}\end{matrix} ] + [ \begin{matrix}{γ}_{p} \\ {γ}_{q}\end{matrix} ] , \qquad ( 36 )$$

where p_{L} and p₀ represent a pressure vector at the outlet and inlet of the pipeline, respectively; q_{L} and q₀ represent a flow vector at the outlet and inlet of the pipeline, respectively; H₁ to H₄ represent constant coefficient matrices with the dimension of Nₜ×Nₜ; and γₚ and γ_{q} represent a constant coefficient vector of pressure and mass flow with the dimension of Nₜ×1, respectively, determined by the initial conditions; the elements may be represented as follows:

$$\{ \begin{matrix}{p}_{0} = [ {p}_{0 , 1} , … , {p}_{0 , Nt} ] , {p}_{L} = [ {p}_{L , 1} , … , {p}_{L , Nt} ] \\ {q}_{L} = [ {q}_{L , 1} , … , {q}_{L , Nt} ] , {q}_{0} = [ {q}_{0 , 1} , … , {q}_{0 , Nt} ]\end{matrix} , \qquad ( 37 )$$

$${γ}_{p , j} = {\sum }_{n 1}^{∞} ( {u}_{n , 0} + {E}_{1 n} {m}_{0} ) {( - 1 )}^{n - 1} {e}^{- {g}_{n} {t}_{j}} , \qquad ( 38 )$$

$${γ}_{q , j} = \frac{DS π}{λ wL} {\sum }_{n - 1}^{∞} ( 1 - 2 n ) ( {u}_{n , 0} + {E}_{1 n} {m}_{0} ) {e}^{- {g}_{n} {t}_{j}} , \qquad ( 39 )$$

$${H}_{1} = 1 , {H}_{3} = 0 , {{H}_{2. ji}}_{i > j} = {{H}_{4. ji}}_{i > j} = 0 , \qquad ( 40 )$$

$${{H}_{2 , ji}}_{i = j} = \frac{λ w}{2 DS} ( {\sum }_{n = 1}^{∞} {{E}_{1 n} ( - 1 )}^{n - 1} {e}^{- {g}_{n} Δ t} - L ) , \qquad ( 41 )$$

$${{H}_{2 , ji}}_{( i < j )} = \frac{λ w}{2 DS} ( {\sum }_{n = 1}^{∞} {{E}_{1 n} ( - 1 )}^{n - 1} \frac{1 - {e}^{{g}_{n} Δ t}}{{e}^{{g}_{n} ( j - i + 1 ) Δ t}} ) , \qquad ( 42 )$$

$${{H}_{4 , ij}}_{( i = j )} = \frac{π}{2 L} {\sum }_{n = 1}^{∞} {E}_{1 n} ( 1 - 2 n ) {e}^{- {g}_{n} Δ t} + 1 , \qquad ( 43 )$$

$${{H}_{4 , ji}}_{( i < j )} = \frac{π}{2 L} {\sum }_{n = 1}^{∞} {E}_{1 n} ( 1 - 2 n ) \frac{1 - {e}^{{g}_{n} Δ t}}{{e}^{{g}_{n} ( j - i + 1 ) Δ t}} ; \qquad ( 44 )$$

defining the number of nodes and pipelines in the natural gas system as N_{g} and N_{b}, respectively, and defining an identity matrix and a zero matrix as 1 and 0, respectively; introducing incidence matrices Aᵢₙ, Aₒᵤₜ, A_{nb1}, and A_{nb2} to describe topological properties in the natural gas system,
where Aᵢₙ includes N_{g}×N_{b} sub-matrices for associating flow at end of a branch with flow at a node, and in response to a sub-matrix of an i-th row and j-th column being 1, the flow flows from the end of the branch j into the node i, otherwise, the sub-matrix is 0; Aₒᵤₜ includes N_{g}×N_{b} sub-matrices for associating flow at head end of a branch with flow at a node, and in response to a sub-matrix of an i-th row and j-th column being 1, the flow flows from the node i into the head end of the branch j, otherwise, the sub-matrix is 0; A_{nb1} includes N_{b}×N_{g} sub-matrices for associating pressure at end of a branch with pressure at a node, and in response to a sub-matrix of an i-th row and j-th column being 1, pressure at the node j is equal to pressure at the end of the branch i, otherwise, the sub-matrix is 0; A_{nb2} includes N_{b}×N_{g} sub-matrices for associating pressure at a head end of a branch with pressure at a node, and in response to a sub-matrix of an i-th row and j-th column being 1, pressure at the node j is equal to pressure at the head end of the branch i, otherwise, the sub-matrix is 0; particularly, in response to the node j being a compressor node with a pressure ratio of K_{cp} and the node j being connected to the head end of the branch i, the sub-matrix of the i-th row and jth column is K_{cp}×1;
constructing, based on the incidence matrices, equations of mass conservation at nodes and pressure continuity between nodes and pipelines, expressed as follows:

$${A}_{in} {q}_{L} - {A}_{out} {q}_{0} = qn ; \qquad ( 45 )$$

$${p}_{L} = {A}_{nb 1} pn , {p}_{0} = {A}_{nb 2} pn ; \qquad ( 46 )$$

where pn and qn represent a pressure and a vector at the node, respectively; p_{L}, p₀, q_{L}, and q₀ are all vectors of Nt×1; the sub-matrices 1 and 0 in coefficient matrices Aᵢₙ, Aₒᵤₜ, A_{nb1}, and Aₒᵤₜ₂ are all Nt×Nt matrices;
substituting Eq. (46) into a first row of Eq. (36) as follows:

$${q}_{L} = {H}_{2}^{- 1} ( ( {A}_{nb 1} - {A}_{{nb}_{2}} ) pn - {γ}_{p} ) = {H}_{a 1} pn + {H}_{a 2} , \qquad ( 47 )$$

where Hₐ₁ and Hₐ₂ represent a constant coefficient matrix and a vector describing mass flow at an outlet of a pipeline, respectively; Eq. (46) and Eq. (47) are substituted into a second row of Eq. (36) as follows:

$${q}_{0} = {H}_{4} ( {H}_{a 1} pn + {H}_{a 2} ) + {γ}_{q} = {H}_{{a}_{3}} pn + {H}_{{a}_{4}} , \qquad ( 48 )$$

where Hₐ₃ and Hₐ₄ represent a constant coefficient matrix and a vector describing mass flow at an inlet of the pipeline, respectively; Eq. (47) and Eq. (48) are substituted into Eq. (45) to associate pressure and mass flow at the node as follows:

$$qn \begin{matrix}= ( {A}_{in} {H}_{a 1} - {A}_{out} {H}_{a 3} ) pn + ( {A}_{in} {H}_{a 2} - {A}_{out} {H}_{a 4} ) \\ = {H}_{a 5} pn + {H}_{a 6}\end{matrix} , \qquad ( 49 )$$

where Hₐ₅ and Hₐ₆ are a constant coefficient matrix and a vector describing a relationship between pressure and mass flow at a node, respectively; subscripts sr and ns are defined as a variable identification of a gas source node and a gas load node, respectively, and Eq. (49) is expanded to obtain the natural gas network equivalent model based on the practical analytical expressions:

$$[ \begin{matrix}{qn}_{sr} \\ {qn}_{ns}\end{matrix} ] = [ \begin{matrix}{H}_{a 51} & {H}_{a 52} \\ {H}_{a 53} & {H}_{a 54}\end{matrix} ] [ \begin{matrix}{pn}_{sr} \\ {pn}_{ns}\end{matrix} ] + [ \begin{matrix}{H}_{a 61} \\ {H}_{a 62}\end{matrix} ] , \qquad ( 50 )$$

where Hₐ₅₁, Hₐ₅₂, Hₐ₅₃, and Hₐ₅₄ are sub-matrices in Hₐ₅, and Hₐ₆₁ and Hₐ₆₂ are sub-vectors in Hₐ₆; pnₛᵣ and pnₙₛ are a pressure vector at a source node and a load node, respectively; qnₛᵣ and qnₙₛ are a mass flow vector at the source node and the load node, respectively; the mass flow at the source node and the pressure at the load node in the natural gas system are fully expressed as functions of the boundary conditions using matrix transformation, namely, a simplified method of natural gas network equivalent model is as follows:

$${pn}_{ns} = {H}_{a 54}^{- 1} ( {qn}_{ns} - {H}_{a 53} {pn}_{sr} - {H}_{a 62} ) , \qquad ( 51 )$$

$${qn}_{sr} = {H}_{a 51} {pn}_{sr} + {H}_{a 52} {pn}_{ns} + {H}_{a 61} . \qquad ( 52 )$$

The beneficial effects of the present disclosure are as follows:

This method directly establishes an analytical solution for the dynamic model of natural gas system. Compared to traditional numerical methods based on discretization, this method completely avoids approximation errors, numerical dispersion, and dissipation. Additionally, by avoiding the discretization process during the solution, this method significantly improves the computational efficiency and solution accuracy of dynamic analysis of the natural gas system.

### BRIEF DESCRIPTION OF THE DRAWINGS

The disclosure will now be further described with reference to the drawings.

FIG. 1 is a specific flow chart of the present disclosure;

FIG. 2 is a structural diagram of a natural gas system in an exemplary embodiment of the present disclosure; and

FIG. 3 is a calculation result graph of mass flow at a node in a natural gas system of the present disclosure.

### DETAILED DESCRIPTION

The technical solutions in the embodiments of the present disclosure will be described clearly and completely below in combination with the drawings in the embodiments of the present disclosure. Clearly, the described embodiment is not all but only part of embodiments of the present disclosure. All other embodiments obtained by those ordinarily skilled in the art based on the embodiments in the present disclosure without creative work shall fall within the scope of protection of the present disclosure.

In the description of this specification, references to the terms “one embodiment”, “an example”, “a specific example”, and the like indicate that a specific feature, structure, material, or characteristic described in connection with the embodiment or example is included in at least one embodiment or example of the present disclosure. In this specification, schematic representations of the above terms do not necessarily refer to the same embodiment or example. Furthermore, the specific feature, structure, material, or characteristic described may be combined in any suitable manner in any one or more embodiments or examples.

Embodiment: Taking the natural gas system shown in FIG. 2 as an example, the state distribution is studied under given initial conditions and boundary conditions.

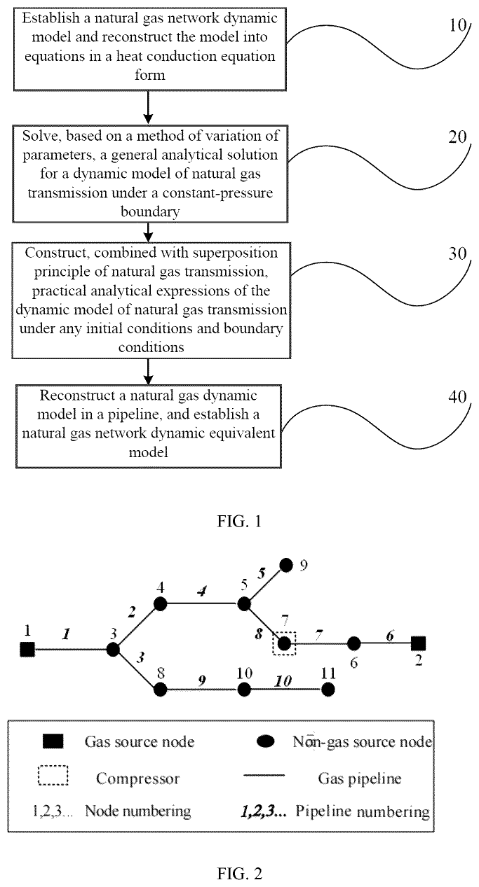

As shown in FIG. 1, an embodiment of the present disclosure provides an analytical method for dynamic analysis of a natural gas system, including the following steps:

At step 10, a dynamic model of natural gas transmission is established according to the conservation equations and reconstructed into the equations in a heat conduction equation form.

At step 101, a dynamic model of natural gas transmission is established in a pipeline, including a mass conservation equation and a momentum conservation equation as below:

$$\frac{\partial {p}_{x , t}}{\partial t} + \frac{{c}^{2}}{s} \frac{\partial {q}_{x , t}}{\partial x} = 0 , \frac{\partial {p}_{x , t}}{\partial t} + \frac{λ {wq}_{x , t}}{2 SD} = 0 , \qquad ( 1 )$$

where x and t represent space and time, respectively, and c represents a speed of sound, taken as 340 m/s; p_{x,t} represents a pressure of natural gas, Pa; q_{x,t} represents mass flow of natural gas, kg/s; w represents an average velocity of natural gas, m/s; D represents an inner diameter of the pipeline, m; S represents a cross-sectional area of the pipeline, m²; and λ represents a resistance coefficient of the pipeline. In addition, initial conditions and boundary conditions are set in the dynamic analysis of the natural gas system as follows:

$${p}_{x , 0} = {φ}_{p , x} , {q}_{x , 0} = {φ}_{q , x} , {p}_{0 , t} , {q}_{L , t} , \qquad ( 2 )$$

where p_{x,0} and q_{x,0} represent distributions of pressure and mass flow in the pipeline at moment 0 respectively, namely, the initial conditions; φ_{p,x} and φ_{q,x} represent initial condition functions of pressure and mass flow, respectively; L represents a length of the pipeline, m; p_{0,t} represents a time-series of pressure at an inlet of the pipeline, namely, pressure boundary; and q_{L,t} represents a time-series function of mass flow at an outlet of the pipeline, namely, flow boundary.

At step 102, a partial derivative for x is derived from a second equation in Eq. (1) before substituting into a first equation in Eq. (1) to obtain a heat conduction form equation as follows:

$$\frac{\partial {q}_{x , t}}{\partial x} = \frac{- 2 DS}{λ w} \frac{{\partial }^{2} {p}_{x , t}}{\partial {x}^{2}} ⇒ \{ \begin{matrix}\frac{\partial {p}_{x , t}}{\partial t} = α \frac{{\partial }^{2} {p}_{x , t}}{\partial {x}^{2}} \\ α = \frac{2 {Dc}^{2}}{λ w}\end{matrix} , \qquad ( 3 )$$

where α is a coefficient term in the heat conduction form equation; accordingly, the partial derivative of pipeline outlet pressure for x can be obtained through the following equation and is defined as mₜ:

$$\frac{\partial p}{\partial x} {\vert}_{x = L} = - \frac{λ w}{2 DS} {q}_{L , t} = {m}_{t} . \qquad ( 4 )$$

Eq. (1) may be converted to as follows:

$$\{ \begin{matrix}\frac{\partial {p}_{x , t}}{\partial t} = α \frac{{\partial }^{2} {p}_{x , t}}{\partial {x}^{2}} , \frac{\partial {p}_{x , t}}{\partial t} {\vert}_{x = L} = {m}_{t} \\ p ( 0 , t ) = {p}_{0 , t} , p ( x , 0 ) = {φ}_{p , x}\end{matrix} . \qquad ( 5 )$$

At step 20, the reconstructed dynamic model of natural gas transmission is transformed into a partial differential equation set with homogeneous boundary conditions using a method of variation of parameters, followed by deriving a general analytical expression for the dynamic model for natural gas transmission when the pressure boundary is constant.

At step 201, p_{0,t} is taken constant with the value of ψ_{p,1} in response to the pressure boundary being constant, followed by introducing an intermediate variable u_{x,t} and reconstructing p_{x,t} as follows:

$${p}_{x , t} = {u}_{x , t} + x ( \frac{\partial p}{\partial x} {\vert}_{x = L} ) + {p}_{0 , t} . \qquad ( 6 )$$

x=0 and t=0 are substituted into Eq. (6) to obtain initial conditions and a set of boundary conditions for u_{x,t}, respectively:

$$\{ \begin{matrix}{u}_{x , 0} = {p}_{x , 0} - x ( \frac{\partial p}{\partial x} {\vert}_{x = L} ) {\vert}_{t = 0} - {p}_{0 , 0} \\ {p}_{0 , t} = {u}_{0 , t} + {p}_{0 , t} ⇒ {u}_{0 , t} = 0\end{matrix} . \qquad ( 7 )$$

A partial derivative for x is derived on both sides of Eq. (6) at x=L to obtain a further set of boundary conditions for u_{x,t}, expressed as follows:

$$\frac{\partial {p}_{x , t}}{\partial x} = \frac{\partial {u}_{x , t}}{\partial x} + \frac{\partial {p}_{x , t}}{\partial x} {\vert}_{x = L} ⇒ \frac{\partial {u}_{x , t}}{\partial x} {\vert}_{x = L} = 0. \qquad ( 8 )$$

A second-order partial derivative for x and a first-order partial derivative for t are derived on both sides of Eq. (6), respectively:

$$\frac{{\partial }^{2} {p}_{x , t}}{\partial {x}^{2}} = \frac{\partial {u}_{x , t}^{2}}{\partial {x}^{2}} , \frac{\partial {p}_{x , t}}{\partial t} = \frac{\partial {u}_{x , t}}{\partial t} + x \frac{\partial }{\partial t} ( \frac{\partial p}{\partial x} {\vert}_{x = L} ) . \qquad ( 9 )$$

Eq. (9) is substituted into Eq. (5), with Eq. (5) re-expressing a partial differential equation set with homogeneous boundary conditions as follows:

$$\{ \begin{matrix}\frac{\partial {u}_{x , t}}{\partial t} = α \frac{{\partial }^{2} {u}_{x , t}}{\partial {x}^{2}} + {f}_{x , t} \\ {u}_{x , 0} = {p}_{x , 0} - x ( \frac{\partial p}{\partial x} {\vert}_{x = L} ) {\vert}_{t = 0} - {p}_{, 0 , 0} , \frac{\partial {u}_{x , t}}{\partial x} {\vert}_{x = L} = 0 \\ {u}_{0 , t} = 0 , {f}_{x , t} = - x \frac{\partial }{\partial t} ( \frac{\partial p}{\partial x} {\vert}_{x = L} ) = - x \frac{\partial {m}_{t}}{\partial t}\end{matrix} . \qquad ( 10 )$$

At step 202, u_{x,t}* is defined as a solution of a homogeneous problem of Eq. (10), and the homogeneous problem is solved as follows:

$${u}_{x , t}^{*} = {T}_{0} ( t ) {\sum }_{n = 1}^{∞} {k}_{2} sin \frac{( 2 n - 1 ) π x}{2 L} , \qquad ( 11 )$$

where k₂ represents a coefficient term; T₀(t) represents a function component about time in u_{x,t}*; n represents the number of Fourier components; analogy to a form of u_{x,t}*, a form of u_{x,t} in Eq. (10) is as follows:

$${u}_{x , t} = {\sum }_{n = 1}^{∞} {u}_{n , t} sin \frac{( 2 n - 1 ) π x}{2 L} , \qquad ( 12 )$$

where u_{n,t} represents a function component about time in u_{x,t}, f_{x,t} in Eq. (10) is expanded according to a base in Eq. (11):

$${f}_{x , t} = {\sum }_{n = 1}^{∞} {f}_{n , t} sin \frac{( 2 n - 1 ) π x}{2 L} , \qquad ( 13 )$$

$${f}_{n , t} = \frac{2}{L} {\int }_{0}^{L} {f}_{x , t} sin \frac{( 2 n - 1 ) π x}{2 L} dx , \qquad ( 14 )$$

where f_{n,t} represents a function component about time in f_{x,t}, obtained by inverse Fourier transformation shown in Eq. (14); Eq. (12) to (14) are substituted into a first equation in Eq. (10):

$$\{ \begin{matrix}\frac{\partial {u}_{n , t}}{\partial t} + {g}_{n} {u}_{n , t} = {f}_{n , t} \\ {g}_{n} = \frac{{( 2 n - 1 )}^{2} {π}^{2} α}{4 {L}^{2}} \\ {u}_{n , 0} = \frac{2}{L} {\int }_{0}^{L} {u}_{x , 0} sin \frac{( 2 n - 1 ) π x}{2 L} dx\end{matrix} , \qquad ( 15 )$$

where gₙ represents a coefficient term in an n-th nonhomogeneous partial differential, u_{n,0} represents a value of u_{n,t} when t=0; Eq. (15) is solved to obtain analytical expressions for u_{n,t} and u_{x,t}, respectively as follows:

$${u}_{n , t} = {e}^{- {g}_{n} t} \{ {u}_{n , 0} + {\int }_{0}^{t} {f}_{n , τ} {e}^{{g}_{n} τ} d τ \} , \qquad ( 16 )$$

$${u}_{x , t} = {\sum }_{n = 1}^{∞} {e}^{- {g}_{n} t} \{ {u}_{n , 0} + {\int }_{0}^{t} {f}_{n , τ} {e}^{{g}_{n} τ} d τ \} sin \frac{( 2 n - 1 ) π x}{2 L} . \qquad ( 17 )$$

Eq. (17) is substituted into Eq. (6) to obtain an analytical expression for p_{x,t} at constant pressure:

$${p}_{x , t} = {\sum }_{n = 1}^{∞} {e}^{- {g}_{n} t} \{ {u}_{n , 0} + {\int }_{0}^{t} {f}_{n , τ} {e}^{{g}_{n} τ} d τ \} sin \frac{( 2 n - 1 ) π x}{2 L} - \frac{λ w x}{2 D s} {q}_{L , t} + {p}_{0 , t} . \qquad ( 18 )$$

Eq. (18) is substituted into a second equation in Eq. to obtain an analytical expression for q_{x,t} at constant pressure:

$${q}_{x , t} = - \frac{2 D S}{λ w} \frac{\partial {p}_{x , t}}{\partial x} = {q}_{L , t} + \{ {\sum }_{n = 1}^{∞} \frac{( 1 - 2 n ) π D S}{λ w L {e}^{{g}_{n} t}} \{ {u}_{n , 0} + {\int }_{0}^{t} {f}_{n , τ} {e}^{{g}_{n} τ} d τ \} cos \frac{( 2 n - 1 ) π x}{2 L} \} , \qquad ( 19 )$$

where p_{0,t} represents a constant-voltage boundary, taking a constant value.

Eq. (18) and Eq. (19) are general analytical expressions for the partial differential equation set of the dynamic model for natural gas transmission under constant pressure boundaries.

At step 30, a practical analytical expression for the dynamic model for natural gas transmission is constructed combining the superposition principle of natural gas transmission and according to the discrete form of the initial conditions and boundary conditions.

At step 301, first, the pressure boundary is reconstructed, expressed as:

$$\{ \begin{matrix}{ψ}_{p} = [ {ψ}_{p , 1} {ψ}_{p , 2} , … , {ψ}_{p , Nt} ] \\ {ψ}_{p , i} = \{ \begin{matrix}{p}_{0 , i} & i = 1 \\ {p}_{0 , i} - {p}_{0 , i - 1} & i > 1\end{matrix}\end{matrix} , {t}_{i} = i Δ t , \qquad ( 20 )$$

where Nt represents a length of the boundary condition, and Δt is a time step; ψₚ represents a new boundary condition corresponding to a pressure increment, and an element ψ_{p,i} represents an increment of a pressure at moment tᵢ for a pressure at moment tᵢ₋₁.

At step 302, according to superposition principle of natural gas transmission, the pressures p_{x,t} is decomposed as follows:

$${p}_{x , t} = {\sum }_{k = 1}^{i} {χ}_{k , x , t - {t}_{k - 1}} 1 \leq i \leq N t , {t}_{k - 1} \leq t \leq {t}_{i} , \qquad ( 21 )$$

where each component χ_{k,x,t} satisfies:

$$\{ \begin{matrix}\frac{\partial {χ}_{k , x , t - {t}_{k - 1}}}{\partial t} = α \frac{{\partial }^{2} {χ}_{k , x , t - {t}_{k - 1}}}{\partial {x}^{2}} , & t > {t}_{k - 1} , 0 < x < L \\ {\frac{\partial {χ}_{k , x , t - {t}_{k - 1}}}{\partial t} \vert}_{x = L} = \{ \begin{matrix}{m}_{t} & k = 1 \\ 0 & k > 1\end{matrix} , & t > {t}_{k - 1} \\ {{χ}_{k , x , t - {t}_{k - 1}} \vert}_{x = 0} = {ψ}_{p , k} , & t > {t}_{k - 1} \\ {{χ}_{k , x , t - {t}_{k - 1}} \vert}_{t = {t}_{k - 1}} = \{ \begin{matrix}{φ}_{p , x} & k = 1 \\ 0 & k > 1\end{matrix} , & 0 \leq x \leq L\end{matrix} . \qquad ( 22 )$$

When k=1, a form of χ_{k,x,t} is consistent with Eq. (18), namely:

$${χ}_{k , x , t - {t}_{k - 1}} = {\sum }_{n = 1}^{∞} {e}^{- {g}_{n} t} \{ {u}_{n , 0} + {\int }_{0}^{t} {f}_{n , τ} {e}^{{g}_{n} τ} d τ \} sin \frac{( 2 n - 1 ) π x}{2 L} + x {m}_{t} + {ψ}_{p , 1} \\ k = 1 , t > {t}_{k - 1} . \qquad ( 23 )$$

When k>1, a form of χ_{k,x,t} is as follows:

$${χ}_{k , x , t - {t}_{k - 1}} = {ψ}_{p , k} k > 1 , t > {t}_{k - 1} . \qquad ( 24 )$$

Eq. (23) and Eq. (24) are substituted into Eq. (21), it may be found that at any pressure boundary, the analytical expressions for p_{x,t} and q_{x,t} are still as shown in Eq. (18) and Eq. (19) with the difference that p_{0,t} is transformed from a constant to a set of discrete sequences.

At step 303, the initial conditions are calculated according to steady-state energy flow in practice, expressed as follows:

$${φ}_{p , x} = {K}_{1} x + {K}_{2} , {φ}_{q , x} = {K}_{3} , {m}_{0} = \frac{- λ w {φ}_{q , L}}{2 D s} , \qquad ( 25 )$$

where K₁, K₂, and K₃ represent constant coefficients in the initial conditions; m₀ represents a value of mₜ at t=0; and φ_{q,L} represents a value of the initial conditions of mass flow at x=L, namely, the mass flow at an outlet of the pipeline at t=0. mₜ is expressed as a segmented step function as follows:

$${m}_{t} = {\sum }_{i = 1}^{Nt} {m}_{i} ( {δ}_{t - {t}_{i}} - {δ}_{t - {t}_{i - 1}} ) t > 0. \qquad ( 26 )$$

f_{x,t} in Eq. (10) and f_{n,t} in Eq. (14) are substituted into Eq. (16) as follows:

$$= {\int }_{0}^{t} ( \frac{- 2}{L} {\int }_{0}^{L} x \frac{\partial {m}_{τ}}{\partial τ} sin \frac{( 2 n - 1 ) π x}{2 L} d x ) {e}^{{g}_{n}^{τ}} d τ$$

$${\int }_{0}^{t} {f}_{n , π} {e}^{{g}_{n}^{τ}} d τ = \frac{- 2}{L} {\int }_{0}^{L} x sin \frac{( 2 n - 1 ) π x}{2 L} d x {\int }_{0}^{t} \frac{\partial {m}_{τ}}{\partial τ} {e}^{{g}_{n}^{τ}} d τ . \qquad ( 27 )$$

$$= \frac{8 {L ( - 1 )}^{n}}{{( 2 n - 1 )}^{2} {π}^{2}} {\int }_{0}^{t} \frac{\partial {m}_{τ}}{\partial τ} {e}^{{g}_{n}^{τ}} d τ$$

An integral formula in Eq. (27) may be modified as follows:

$$\frac{\partial {m}_{τ}}{\partial τ} {e}^{{g}_{n} τ} = \frac{\partial ( {m}_{τ} {e}^{{g}_{n} τ} )}{\partial τ} - {g}_{n} {m}_{τ} {e}^{{g}_{n} τ} , \qquad ( 28 )$$

$${g}_{n} {\int }_{0}^{{t}_{k}} {m}_{τ} {e}^{{g}_{n} τ} d τ = {\sum }_{i = 1}^{k} {m}_{i} ( {e}^{{g}_{n} {t}_{i}} - {e}^{{g}_{n} {t}_{i - 1}} ) . \qquad ( 29 )$$

Eq. (28) and Eq. (29) are substituted into Eq. (27) as follows:

$$\frac{1}{{e}^{{g}_{n} {t}_{k}}} {\int }_{0}^{{t}_{k}} {f}_{n , τ} {e}^{{g}_{n} τ} d τ = - {E}_{1 n} ( {m}_{k} - \frac{{m}_{0}}{{e}^{{g}_{n} {t}_{k}}} - {\sum }_{i = 1}^{k} {m}_{i} \frac{{e}^{{g}_{n} Δ t} - 1}{{e}^{{g}_{n} ( {t}_{k} - {t}_{i - 1} )}} ) , \qquad ( 30 )$$

$${E}_{1 n} = \frac{8 {L ( - 1 )}^{n - 1}}{{( 2 n - 1 )}^{2} {π}^{2}} . \qquad ( 31 )$$

Eq. (30) is substituted into Eq. (18) and Eq. (19), to obtain the practical analytical expressions for the dynamic model for natural gas transmission as follows:

$${p}_{x , k} = {\sum }_{n = 1}^{∞} \{ \frac{{u}_{n , 0}}{{e}^{{g}_{n} {t}_{k}}} - {E}_{1 n} ( {m}_{k} - \frac{{m}_{0}}{{e}^{{g}_{n} {t}_{k}}} - {\sum }_{i = 1}^{k} {m}_{i} \frac{{e}^{{g}_{n} Δ t} - 1}{{e}^{{g}_{n} ( {t}_{k} - {t}_{i - 1} )}} ) \} sin \frac{( 2 n - 1 ) π x}{2 L} - \frac{λ w x}{2 D S} {q}_{L , k} + {p}_{0 , k} , \qquad ( 32 )$$

$${q}_{x , k} = {q}_{L , k} + \{ {\sum }_{n = 1}^{∞} \frac{( 1 - 2 n ) π D S}{λ w L} \{ \frac{{u}_{n , 0}}{{e}^{{g}_{n} {t}_{k}}} - {E}_{1 n} ( {m}_{k} - \frac{{m}_{0}}{{e}^{{g}_{n} {t}_{k}}} - {\sum }_{i = 1}^{k} {m}_{i} \frac{{e}^{{g}_{n} Δ t} - 1}{{e}^{{g}_{n} ( {t}_{k} - {t}_{i - 1} )}} ) \} cos \frac{( 2 n - 1 ) π x}{2 L} \} . \qquad ( 33 )$$

At step 40, the dynamic model of natural gas transmission is reconstructed; and the natural gas network equivalent model is derived based on the analytical method, as well as the simplified analysis method thereof combining topological characteristics, the time-invariant and causal properties of natural gas transmission.

At step 401, x=L and x=0 are substituted into Eq. (32) and Eq. (33), respectively, to obtain pressure at the outlet and flow at the inlet of the pipeline at arbitrary tⱼ as follows:

$${p}_{L , j} = {\sum }_{n = 1}^{∞} {e}^{- {g}_{n} {t}_{j}} {{u}_{n , 0} ( - 1 )}^{n - 1} - \frac{λ w L}{2 D s} {q}_{L , j} + {p}_{0 , j} + {\sum }_{n = 1}^{∞} \frac{λ w {E}_{1 n}}{2 D s} {( - 1 )}^{n - 1} ( {q}_{L , j} - \frac{{q}_{L , 0}}{{e}^{{g}_{n} {t}_{j}}} - {\sum }_{i = 1}^{j} {q}_{L , i} \frac{{e}^{{g}_{n} Δ t} - 1}{{e}^{{g}_{n} ( j - i + 1 ) Δ t}} ) , \qquad ( 34 )$$

$${q}_{0 , j} = {q}_{L , j} + \frac{D s π}{λ w L} {\sum }_{n - 1}^{∞} ( 1 - 2 n ) {u}_{n , 0} {e}^{- {g}_{n} {t}_{j}} + \frac{π}{2 L} {\sum }_{n - 1}^{∞} ( 1 - 2 n ) {E}_{1 n} ( {q}_{L , j} - \frac{{q}_{L , 0}}{{e}^{{g}_{n} {t}_{j}}} - {\sum }_{i = 1}^{j} {q}_{L , i} \frac{{e}^{{g}_{n} Δ t} - 1}{{e}^{{g}_{n} ( j - i + 1 ) Δ t}} ) . \qquad ( 35 )$$

Eq. (34) and Eq. (35) are reorganized as follows:

$$[ \begin{matrix}{p}_{L} \\ {q}_{0}\end{matrix} ] = [ \begin{matrix}{H}_{1} & {H}_{2} \\ {H}_{3} & {H}_{4}\end{matrix} ] [ \begin{matrix}{p}_{0} \\ {q}_{L}\end{matrix} ] + [ \begin{matrix}{γ}_{p} \\ {γ}_{q}\end{matrix} ] , \qquad ( 36 )$$

where p_{L} and p₀ represent a pressure vector at the outlet and inlet of the pipeline, respectively; q_{L} and q₀ represent a flow vector at the outlet and inlet of the pipeline, respectively; H₁₋₄ represent constant coefficient matrices with the dimension of Nₜ×Nₜ; and γₚ and γ_{q} represent a constant coefficient vector of pressure and mass flow with the dimension of Nₜ×1, respectively, determined by the initial conditions; the elements may be represented as follows:

$$\{ \begin{matrix}{p}_{0} = [ {p}_{0 , 1} , ⋯ , {p}_{0 , Nt} ] , & {p}_{L} = [ {p}_{L , 1} , ⋯ , {p}_{L , Nt} ] \\ {q}_{L} = [ {q}_{L , 1} , ⋯ , {q}_{L , Nt} ] , & {q}_{0} = [ {q}_{0 , 1} , ⋯ , {q}_{0 , Nt} ]\end{matrix} , \qquad ( 37 )$$

$${γ}_{p , j} = {\sum }_{n = 1}^{∞} ( {u}_{n , 0} + {E}_{1 n} {m}_{0} ) {( - 1 )}^{n - 1} {e}^{- {g}_{n} {t}_{j}} , \qquad ( 38 )$$

$${γ}_{q , j} = \frac{DS π}{λ wL} {\sum }_{n - 1}^{∞} ( 1 - 2 n ) ( {u}_{n , 0} + {E}_{1 n} {m}_{0} ) {e}^{- {g}_{n} {t}_{j}} , \qquad ( 39 )$$

$${H}_{1} = 1 , {H}_{3} = 0 , {{H}_{2. ji}}_{i > j} = {{H}_{4. ji}}_{i > j} = 0 , \qquad ( 40 )$$

$${{H}_{2 , ji}}_{i = j} = \frac{λ w}{2 DS} ( {\sum }_{n = 1}^{∞} {E}_{1 n} {( - 1 )}^{n - 1} {e}^{- {g}_{n} Δ t} - L ) , \qquad ( 41 )$$

$${{H}_{2 , ji}}_{( i < j )} = \frac{λ w}{2 DS} ( {\sum }_{n = 1}^{∞} {E}_{1 n} {( - 1 )}^{n - 1} \frac{1 - {e}^{{g}_{n} Δ t}}{{e}^{{g}_{n} ( j - i + 1 ) Δ t}} ) , \qquad ( 42 )$$

$${{H}_{4 , ij}}_{( i = j )} = \frac{π}{2 L} {\sum }_{n = 1}^{∞} {E}_{1 n} ( 1 - 2 n ) {e}^{- {g}_{n} Δ t} + 1 , \qquad ( 43 )$$

$${{H}_{4 , ji}}_{( i < j )} = \frac{π}{2 L} {\sum }_{n = 1}^{∞} {E}_{1 n} ( 1 - 2 n ) \frac{I - {e}^{{g}_{n} Δ t}}{{e}^{{g}_{n} ( j - i + 1 ) Δ t}} . \qquad ( 44 )$$

At step 402, the number of nodes and pipelines in the natural gas system are defined as N_{g} and N_{b}, respectively, and an identity matrix and a zero matrix are defined as 1 and 0, respectively; incidence matrices are introduced to describe topological properties in the natural gas system.

(1) Aᵢₙ includes N_{g}×N_{b} sub-matrices for associating flow at end of a branch with flow at a node, and in response to a sub-matrix of an i-th row and j-th column being 1, the flow flows from the end of the branch j into the node i, otherwise, the sub-matrix is 0.

(2) Aₒᵤₜ includes N_{g}×N_{b} sub-matrices for associating flow at head end of a branch with flow at a node, and in response to a sub-matrix of an i-th row and j-th column being 1, the flow flows from the node i into the head end of the branch j, otherwise, the sub-matrix is 0.

(3) A_{nb1} includes N_{b}×N_{g} sub-matrices for associating pressure at end of a branch with pressure at a node, and in response to a sub-matrix of an i-th row and j-th column being 1, pressure at the node j is equal to pressure at the end of the branch i, otherwise, the sub-matrix is 0.

(4) A_{nb2} includes N_{b}×N_{g} sub-matrices for associating pressure at a head end of a branch with pressure at a node, and in response to a sub-matrix of an i-th row and j-th column being 1, pressure at the node j is equal to pressure at the head end of the branch i, otherwise, the sub-matrix is 0; particularly, in response to the node j being a compressor node with a pressure ratio of K_{cp} and the node j being connected to the head end of the branch i, the sub-matrix of the i-th row and jth column is K_{cp}×1.

At step 403, equations of mass conservation at nodes and pressure continuity between nodes and pipelines are constructed based on the incidence matrices, expressed as follows:

$${A}_{in} {q}_{L} - {A}_{out} {q}_{0} = qn , \qquad ( 45 )$$

$${p}_{L} = {A}_{nb 1} pn , {p}_{0} = {A}_{nb 2} pn , \qquad ( 46 )$$

where pn and qn represent a pressure and a vector at the node, respectively; p_{L}, p₀, q_{L}, and q₀ are all vectors of Nt×1; the sub-matrices 1 and 0 in coefficient matrices Aᵢₙ, Aₒᵤₜ, A_{nb1}, and Aₒᵤₜ₂ are all Nt×Nt matrices.

Eq. (46) is substituted into a first row of Eq. (36) as follows:

$${q}_{L} = {H}_{2}^{- 1} ( ( {A}_{nb 1} - {A}_{{nb}_{2}} ) pn - {γ}_{p} ) = {H}_{a 1} pn + {H}_{a 2} , \qquad ( 47 )$$

where Hₐ₁ and Hₐ₂ represent a constant coefficient matrix and a vector describing mass flow at an outlet of a pipeline, respectively; Eq. (46) and Eq. (47) are substituted into a second row of Eq. (36) as follows:

$${q}_{0} = {H}_{4} ( {H}_{a 1} pn + {H}_{a 2} ) + {γ}_{q} = {H}_{{a}_{3}} pn + {H}_{{a}_{4}} , \qquad ( 48 )$$

where Hₐ₃ and Hₐ₄ represent a constant coefficient matrix and a vector describing mass flow at an inlet of the pipeline, respectively; Eq. (47) and Eq. (48) are substituted into Eq. (45) to associate pressure and mass flow at the node as follows:

$$qn \begin{matrix}= ( {A}_{in} {H}_{a 1} - {A}_{out} {H}_{a 3} ) p n + ( {A}_{in} {H}_{a 2} - {A}_{out} {H}_{a 4} ) \\ = {H}_{a 5} pn + {H}_{a 6}\end{matrix} , \qquad ( 49 )$$

where Hₐ₅ and Hₐ₆ are a constant coefficient matrix and a vector describing a relationship between pressure and mass flow at a node, respectively; subscripts sr and ns are defined as a variable identification of a gas source node and a gas load node, respectively, and Eq. (49) is expanded to obtain the natural gas network equivalent model based on the practical analytical expressions:

$$[ \begin{matrix}{qn}_{sr} \\ {qn}_{ns}\end{matrix} ] = [ \begin{matrix}{H}_{a 51} & {H}_{a 52} \\ {H}_{a 53} & {H}_{a 54}\end{matrix} ] [ \begin{matrix}{pn}_{sr} \\ {pn}_{ns}\end{matrix} ] + [ \begin{matrix}{H}_{a 61} \\ {H}_{a 62}\end{matrix} ] , \qquad ( 50 )$$

where Hₐ₅₁, Hₐ₅₂, Hₐ₅₃, and Hₐ₅₄ are sub-matrices in Hₐ₅, and Hₐ₆₁ and Hₐ₆₂ are sub-vectors in Hₐ₆; pnₛᵣ and pnₙₛ are a pressure vector at a source node and a load node, respectively; qnₛᵣ and qnₙₛ are a mass flow vector at the source node and the load node, respectively; the mass flow at the source node and the pressure at the load node in the natural gas system are fully expressed as functions of the boundary conditions using matrix transformation, namely, a simplified method of natural gas network equivalent model is as follows:

$${pn}_{ns} = {H}_{a 54}^{- 1} ( {qn}_{ns} - {H}_{a 53} {pn}_{sr} - {H}_{a 62} ) , \qquad ( 51 )$$

$${qn}_{sr} = {H}_{a 51} {pn}_{sr} + {H}_{a 52} {pn}_{ns} + {H}_{a 61} . \qquad ( 52 )$$

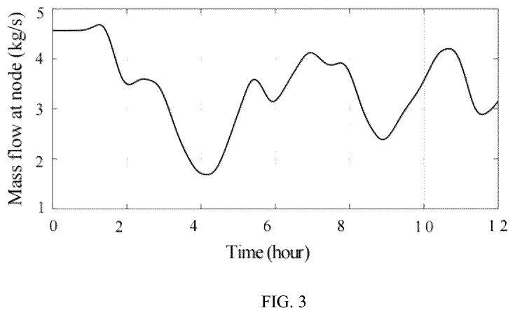

The pressures at load nodes and mass flows at source nodes are calculated using the analytical functions as shown in FIG. 3.

The present disclosure proposes an analytical method for dynamic analysis of a natural gas system, which is based on a dynamic model of the natural gas system. Furthermore, based on the superposition principle, time-invariant and causal properties of natural gas transmission, practical analytical forms of the dynamic model under different initial conditions and boundary conditions, as well as the equivalent network model, are constructed, reducing the computational complexity and greatly improving the computational accuracy.

The foregoing has shown and described the basic principles, principal features, and advantages of the present disclosure. It is to be understood by those skilled in the art that the present disclosure is not limited to the above embodiments. The above embodiments and description in the present disclosure are merely illustrative of the principles of the present disclosure. Without deviating from the spirit and scope of the present disclosure, the present disclosure is subject to various changes and improvements, and these changes and improvements fall within the scope of the present disclosure that requires protection.

1. An analytical method for dynamic analysis of a natural gas network, comprising:
establishing a dynamic model of natural gas transmission according to the conservation equations, and reconstructing the dynamic model into the equations in a heat conduction equation form;
transforming the heat conduction equation into a partial differential equation set with homogeneous boundary conditions using a method of variation of parameters, and constructing a general analytical expression for the partial differential equation set under constant pressure boundaries;
constructing, based on superposition principle, practical analytical expressions for the dynamic model of natural gas transmission;
constructing, according to system topologies and time-invariant, and causal properties of a natural gas system, a natural gas network equivalent model based on the practical analytical expressions; and
determining pressure at load nodes and mass flows at source nodes based on the natural gas network equivalent model.

2. The analytical method for dynamic analysis of a natural gas network according to claim 1, wherein the establishing a dynamic model of natural gas transmission according to the conservation equations comprises the following steps:
establishing a dynamic model of natural gas transmission in a pipeline, comprising a mass conservation equation and a momentum conservation equation as below:
$$\frac{\partial {p}_{x , t}}{\partial t} + \frac{{c}^{2}}{S} \frac{\partial {q}_{x , t}}{\partial x} = 0 , \frac{\partial {p}_{x , t}}{\partial x} + \frac{λ {wq}_{x , t}}{2 SD} = 0 , \qquad ( 1 )$$
where x and t represent space and time, respectively, and c represents a speed of sound, taken as 340 m/s; p_{x,t} represents a pressure of natural gas, Pa; q_{x,t} represents mass flow of natural gas, kg/s; w represents an average velocity of natural gas, m/s; D represents an inner diameter of the pipeline, m; S represents a cross-sectional area of the pipeline, m₂; and λ represents a resistance coefficient of the pipeline; and
setting initial conditions and boundary conditions in the dynamic analysis of the natural gas system as follows:
$${p}_{x , 0} = {φ}_{p , x} , {q}_{x , 0} = {φ}_{q , x} , {p}_{0 , t} , {q}_{L , t} , \qquad ( 2 )$$
where p_{x,0} and q_{x,0} represent distributions of pressure and mass flow in the pipeline at moment 0 respectively, namely, the initial conditions; φ_{p,x} and φ_{q,x} represent initial condition functions of pressure and mass flow, respectively; L represents a length of the pipeline, m; p_{0,t} represents a time-series of pressure at an inlet of the pipeline, namely, pressure boundary; and q_{L,t} represents a time-series function of mass flow at an outlet of the pipeline, namely, flow boundary.

3. The analytical method for dynamic analysis of a natural gas network according to claim 2, wherein the reconstructing the dynamic gas flow model into the equations in a heat conduction equation form comprises the following steps:
deriving a partial derivative for x from a second equation in Eq. before substituting into a first equation in Eq. (1) to obtain a heat conduction form equation as follows:
$$\frac{\partial {q}_{x , t}}{\partial x} = \frac{- 2 DS}{λ w} \frac{{\partial }^{2} {p}_{x , t}}{\partial {x}^{2}} ⇒ \{ \begin{matrix}\frac{\partial {p}_{x , t}}{\partial t} & = α \frac{{\partial }^{2} {p}_{x , t}}{\partial {x}^{2}} \\ α & = \frac{2 {Dc}^{2}}{λ w}\end{matrix} , \qquad ( 3 )$$
where α represents a coefficient term in the heat conduction form equation; accordingly, the partial derivative of pipeline outlet pressure for x can be obtained through the following equation and is defined as mₜ:
$$\frac{\partial p}{\partial x} {\vert}_{x = L} = - \frac{λ w}{2 DS} {q}_{L , t} = {m}_{t} ; \qquad ( 4 )$$
and
Eq. (1) being converted to:
$$\{ \begin{matrix}\frac{\partial {p}_{x , t}}{\partial f} = α \frac{{\partial }^{2} {p}_{x , t}}{\partial {x}^{2}} , & \frac{\partial {p}_{x , t}}{\partial x} {\vert}_{x = L} = {m}_{t} \\ p ( 0 , t ) = {p}_{0 , t} , & p ( x , 0 ) = {φ}_{p , x}\end{matrix} . \qquad ( 5 )$$

4. The analytical method for dynamic analysis of a natural gas network according to claim 3,
wherein the transforming the heat conduction equation into a partial differential equation set with homogeneous boundary conditions using a method of variation of parameters comprises the following steps:
taking, by p_{0,t}, a constant value ψ_{p,1} in response to the pressure boundary being constant; introducing an intermediate variable u_{x,t} and reconstructing p_{x,t} as follows:
$${p}_{x , t} = {u}_{x , t} + x ( \frac{\partial p}{\partial x} {\vert}_{x = L} ) + {p}_{o , t} ; \qquad ( 6 )$$
substituting x=0 and t=0 into Eq. (6) to obtain initial conditions and a set of boundary conditions for u_{x,t}, respectively:
$$\{ \begin{matrix}{u}_{x , 0} = {p}_{x , 0} - x ( \frac{\partial p}{\partial x} {\vert}_{x = L} ) {\vert}_{t = 0} - {p}_{0 , 0} \\ {p}_{0 , t} = {u}_{0 , t} + {p}_{0 , t} ⇒ {u}_{0 , t} = 0\end{matrix} ; \qquad ( 7 )$$
deriving a partial derivative for x on both sides of Eq. (6) at x=L to obtain a further set of boundary conditions for u_{x,t}, expressed as follows:
$${\frac{\partial {p}_{x , t}}{\partial x} = \frac{\partial {u}_{x , t}}{\partial x} + \frac{\partial {p}_{x , t}}{\partial x} \vert}_{x = L} ⇒ \frac{\partial {u}_{x , t}}{\partial x} {\vert}_{x = L} = 0 ; \qquad ( 8 )$$
deriving a second-order partial derivative for x and a first-order partial derivative for t on both sides of Eq. (6), respectively:
$$\frac{{\partial }^{2} {p}_{x , t}}{\partial {x}^{2}} = \frac{\partial {u}_{x , t}^{2}}{\partial {x}^{2}} , \frac{\partial {p}_{x , t}}{\partial t} = \frac{\partial {u}_{x , t}}{\partial t} + x \frac{\partial }{\partial t} ( \frac{\partial {p}_{x , t}}{\partial t} {\vert}_{x = L} ) ; \qquad ( 9 )$$
and
substituting Eq. (9) into Eq. (5), with Eq. (5) re-expressing a partial differential equation set with homogeneous boundary conditions as follows:
$$\{ \begin{matrix}\frac{\partial {u}_{x , t}}{\partial t} = α \frac{{\partial }^{2} {u}_{x , t}}{\partial {x}^{2}} + {f}_{x , t} \\ {{{{u}_{x , 0} = {P}_{x , 0} - x ( \frac{\partial p}{\partial x} \vert}_{x = L} ) \vert}_{t = 0} - {p}_{0 , 0} , \frac{\partial {u}_{x , t}}{\partial x} \vert}_{x = L} = 0 \\ {{u}_{0 , t} = 0 , {f}_{x , t} = - x \frac{\partial }{\partial t} ( \frac{\partial p}{\partial x} \vert}_{x = L} ) = - x \frac{\partial {m}_{t}}{\partial t}\end{matrix} . \qquad ( 10 )$$

5. The analytical method for dynamic analysis of a natural gas network according to claim 4, wherein the constructing a general analytical expression for the partial differential equation set under constant pressure boundaries comprises the following steps:
defining u_{x,t}* as a solution of a homogeneous problem of Eq. (10), and solving the homogeneous problem as follows:
$${u}_{x , t}^{*} = {T}_{0} ( t ) {\sum }_{n = 1}^{∞} {k}_{2} sin \frac{( 2 n - 1 ) π x}{2 L} , \qquad ( 11 )$$
where k₂ represents a coefficient term; T₀(t) represents a function component about time in u_{x,t}*; n represents the number of Fourier components; referring to a form of u_{x,t}* a form of u_{x,t} in Eq. (10) is assumed as follows:
$${u}_{x , t} = {\sum }_{n = 1}^{∞} {u}_{n , t} sin \frac{( 2 n - 1 ) π x}{2 L} , \qquad ( 12 )$$
where u_{n,t} represents a function component about time in u_{x,t}, f_{x,t} in Eq. (10) is expanded according to a base in Eq. (11):
$${f}_{x , t} = {\sum }_{n = I}^{∞} {f}_{n , t} sin \frac{( 2 n - 1 ) π x}{2 L} , \qquad ( 13 )$$
$${f}_{n , t} = \frac{2}{L} {\int }_{0}^{L} {f}_{x , t} sin \frac{( 2 n - 1 ) π x}{2 L} dx , \qquad ( 14 )$$
where f_{n,t} represents a function component about time in f_{x,t}, obtained by inverse Fourier transformation shown in Eq. (14); Eq. (12) to (14) are substituted into a first equation in Eq. (10):
$$\{ \begin{matrix}\frac{\partial {u}_{n , t}}{\partial t} + {g}_{n} {u}_{n , t} = {f}_{n , t} \\ {g}_{n} = \frac{{( 2 n - 1 )}^{2} {π}^{2} a}{4 {L}^{2}} \\ {u}_{n , 0} = \frac{2}{L} {\int }_{0}^{L} {u}_{x , 0} sin \frac{( 2 n - 1 ) π x}{2 L} d x\end{matrix} , \qquad ( 15 )$$
where gₙ represents a coefficient term in an n-th nonhomogeneous partial differential, u_{n,0} represents a value of u_{n,t} when t=0; Eq. (15) is solved to obtain analytical expressions for u_{n,t} and u_{x,t}, respectively as follows:
$${u}_{n , t} = {e}^{- {g}_{n} t} \{ {u}_{n , 0} + {\int }_{0}^{t} {f}_{n , τ} {e}^{{g}_{n} τ} dτ \} , \qquad ( 16 )$$
$${u}_{x , t} = {\sum }_{n = I}^{∞} {e}^{- {g}_{n} t} \{ {u}_{n , 0} + {\int }_{0}^{t} {f}_{n , τ} {e}^{{g}_{n} τ} d τ \} sin \frac{( 2 n - 1 ) π x}{2 L} ; \qquad ( 17 )$$
substituting Eq. (17) into Eq. (6) to obtain an analytical expression for p_{x,t} at constant pressure:
$${p}_{x , t} = {\sum }_{n = 1}^{∞} {e}^{- {g}_{n}^{t}} \{ {u}_{n , 0} + {\int }_{0}^{t} {f}_{n , τ} {e}^{{g}_{n}^{τ}} d τ \} sin \frac{( 2 n - 1 ) π x}{2 L} - \frac{λ w x}{2 D s} {q}_{L , t} + {p}_{0 , t} ; \qquad ( 18 )$$
and
substituting Eq. (18) into a second equation in Eq. (1) to obtain an analytical expression for q_{x,t} at constant pressure:
$${q}_{x , t} = - \frac{2 DS}{λ w} \frac{\partial {p}_{x , t}}{\partial x} = {q}_{L , t} + \{ {\sum }_{n = 1}^{∞} \frac{( 1 - 2 n ) π D S}{λ w L {e}^{{g}_{n}^{t}}} \{ {u}_{n , 0} + {\int }_{0}^{t} {f}_{n , τ} {e}^{{g}_{n}^{τ}} d τ \} cos \frac{( 2 n - 1 ) π x}{2 L} \} , \qquad ( 19 )$$
where p_{0,t} represents a constant-voltage boundary, taking a constant value; Eq. (18) and Eq. (19) are general analytical expressions for the partial differential equation set of the dynamic model for natural gas transmission under constant pressure boundaries.

6. The analytical method for dynamic analysis of a natural gas network according to claim 1, wherein the constructing, based on superposition principle, practical analytical expressions for the dynamic model of natural gas transmission comprises the following steps:
reconstructing the pressure boundary, expressed as follows:
$$\{ \begin{matrix}{ψ}_{p} = [ {ψ}_{p , 1} , {ψ}_{p , 2} , … , {ψ}_{p , Nt} ] \\ {ψ}_{p , i} = \{ \begin{matrix}{p}_{0 , i} & i = 1 \\ {p}_{0 , i} - {p}_{0 , i - 1} & i > 1\end{matrix} , {t}_{i} = i Δ t ,\end{matrix} \qquad ( 20 )$$
where Nt represents a length of the boundary condition, and Δt is a time step; ψₚ represents a new boundary condition corresponding to a pressure increment, and an element ψ_{p,i} represents an increment of a pressure at moment tᵢ for a pressure at moment tᵢ₋₁;
decomposing, according to superposition principle of natural gas transmission, the pressures p_{x,t} as follows:
$${P}_{x , t} = {\sum }_{k = 1}^{i} {χ}_{k , x , t - {t}_{k - 1}} 1 \leq i \leq N t , {t}_{k - 1} \leq t \leq {t}_{i} , \qquad ( 21 )$$
where each component χ_{k,x,t} satisfies:
$$\{ \begin{matrix}\frac{\partial {χ}_{k , t - {t}_{k - 1}}}{\partial t} = α \frac{{\partial }^{2} {χ}_{k , x , {t}_{k - 1}}}{\partial {x}^{2}} , & t > {t}_{k - 1} , 0 < x < L \\ {\frac{\partial {χ}_{k , x , t - {t}_{k - 1}}}{\partial t} \vert}_{x = L} = \{ \begin{matrix}{m}_{t} & k = 1 \\ 0 & k > 1\end{matrix} , & t > {t}_{k - 1} \\ {{χ}_{k , x , t - {t}_{k - 1}} \vert}_{x = 0} = {ψ}_{p , k} , & t > {t}_{k - 1} \\ {{χ}_{k , x , t - {t}_{k - 1}} \vert}_{t = {t}_{k - 1}} = \{ \begin{matrix}{φ}_{p , x} & k = 1 \\ 0 & k > 1\end{matrix} , & 0 \leq x \leq L\end{matrix} , \qquad ( 22 )$$
when k=1, a form of χ_{k,x,t} is consistent with Eq. (18), namely:
$$\begin{matrix}{χ}_{k , x , t - {t}_{k - 1}} = {\sum }_{n = 1}^{∞} {e}^{- {g}_{n}^{t}} \{ {u}_{n , 0} + {\int }_{0}^{t} {f}_{n , τ} {e}^{{g}_{n}^{τ}} d τ \} sin \frac{( 2 n - 1 ) π x}{2 L} + x {m}_{t} + {ψ}_{p , 1} & k = 1 , t > {t}_{k - 1}\end{matrix} , \qquad ( 23 )$$
when k>1, a form of χ_{k,x,t} is as follows:
$$\begin{matrix}{χ}_{k , x , t - {t}_{k - 1}} = {ψ}_{p , k} & k > 1 , t > {t}_{k - 1}\end{matrix} ; \qquad ( 24 )$$
calculating the initial conditions according to steady-state energy flow in practice, expressed as follows:
$${φ}_{p , k} = {K}_{1} x + {K}_{2} , {φ}_{q , x} = {K}_{3} , {m}_{0} = \frac{- λ w {φ}_{q , L}}{2 DS} , \qquad ( 25 )$$
where K₁, K₂, and K₃ represent constant coefficients in the initial conditions; m₀ represents a value of mₜ at t=0; and φ_{q,L} represents a value of the initial conditions of mass flow at x=L, namely, the mass flow at an outlet of the pipeline at t=0;
expressing mₜ as a segmented step function as follows:
$${m}_{t} = {\sum }_{i = 1}^{Nt} {m}_{i} ( {δ}_{t - {t}_{i}} - {δ}_{t - {t}_{i - 1}} ) t > 0 ; \qquad ( 26 )$$
substituting f_{x,t} in Eq. (10) and f_{n,t} in Eq. (14) into Eq. (16) as follows:
$$\begin{matrix}= {\int }_{0}^{t} ( \frac{- 2}{L} {\int }_{0}^{L} x \frac{\partial {m}_{τ}}{\partial τ} sin \frac{( 2 n - 1 ) π x}{2 L} dx ) {e}^{{g}_{n} τ} d τ \\ {\int }_{0}^{t} {f}_{n , π} {e}^{{g}_{n} τ} d τ = \frac{- 2}{L} {\int }_{0}^{L} x sin \frac{( 2 n - 1 ) π x}{2 L} dx {\int }_{0}^{t} \frac{\partial {m}_{τ}}{\partial τ} {e}^{{g}_{n} τ} d τ \\ \frac{8 {L ( - 1 )}^{n}}{{( 2 n - 1 )}^{2} {π}^{2}} {\int }_{0}^{t} \frac{\partial {m}_{τ}}{\partial τ} {e}^{{g}_{n} τ} d τ\end{matrix} ; \qquad ( 27 )$$
modifying an integral formula in Eq. (27) as follows:
$$\frac{\partial {m}_{τ}}{\partial τ} {e}^{{g}_{n} τ} = \frac{\partial ( {m}_{τ} {e}^{{g}_{n} τ} )}{\partial τ} - {g}_{n} {m}_{τ} {e}^{{g}_{n} τ} , \qquad ( 28 )$$
$${g}_{n} {\int }_{0}^{{t}_{k}} {m}_{τ} {e}^{{g}_{n} τ} d τ = {\sum }_{i = 1}^{k} {m}_{i} ( {e}^{{g}_{n} {t}_{i}} - {e}^{{g}_{n} {t}_{i - 1}} ) ; \qquad ( 29 )$$
substituting Eq. (28) and Eq. (29) into Eq. (27) as follows:
$$\frac{1}{{e}^{{g}_{n} {t}_{k}}} {\int }_{0}^{{t}_{k}} {f}_{n , τ} {e}^{{g}_{n} τ} d τ = - {E}_{1 n} ( {m}_{k} - \frac{{m}_{0}}{{e}^{{g}_{n} {t}_{k}}} - {\sum }_{i = 1}^{k} {m}_{i} \frac{{e}^{{g}_{n} Δ t} - 1}{{e}^{{g}_{n}} ( {t}_{k} - {t}_{i - 1} )} ) , \qquad ( 30 )$$
$${E}_{1 n} = \frac{8 {L ( - 1 )}^{n - 1}}{{( 2 n - 1 )}^{2} {π}^{2}} ; \qquad ( 31 )$$
and
substituting Eq. (30) into Eq. (18) and Eq. (19), to obtain the practical analytical expressions for the dynamic model of natural gas transmission as follows:
$${p}_{x , k} = {\sum }_{n = 1}^{∞} \{ \frac{{u}_{n , 0}}{{e}^{{g}_{n} {t}_{k}}} - {E}_{1 n} ( {m}_{k} - \frac{{m}_{0}}{{e}^{{g}_{n} {t}_{k}}} - {\sum }_{i = 1}^{k} {m}_{i} \frac{{e}^{{g}_{n} Δ t} - 1}{{e}^{{g}_{n}} ( {t}_{k} - {t}_{i - 1} )} ) \} sin \frac{( 2 n - 1 )}{2 L} - \frac{λ wx}{2 DS} {q}_{L , k} + {p}_{0 , k} , \qquad ( 32 )$$
$${q}_{x , k} = {q}_{L , k} + \{ {\sum }_{n = 1}^{∞} \frac{( 1 - 2 n ) π DS}{λ wL} \{ \frac{{u}_{n , 0}}{{e}^{{g}_{n} {t}_{k}}} - {E}_{1 n} ( {m}_{k} - \frac{{m}_{0}}{{e}^{{g}_{n} {t}_{k}}} - {\sum }_{i = 1}^{k} {m}_{i} \frac{{e}^{{g}_{n} Δ t} - 1}{{e}^{{g}_{n}} ( {t}_{k} - {t}_{i - 1} )} ) \} cos \frac{( 2 n - 1 ) π x}{2 L} \} . \qquad ( 33 )$$

7. The analytical method for dynamic analysis of a natural gas network according to claim 1,
wherein the constructing, according to system topologies, and time-invariant, and causal properties of a natural gas system, a natural gas network equivalent model based on the practical analytical expressions comprises the following steps:
substituting x=L and x=0 into Eq. (32) and Eq. (33), respectively, to obtain pressure at the outlet and flow at the inlet of the pipeline at arbitrary tⱼ as follows:
$${p}_{L , j} = {\sum }_{n = 1}^{∞} {e}^{- {g}_{n} {t}_{j}} {{u}_{n , 0} ( - 1 )}^{n - 1} - \frac{λ wL}{2 DS} {q}_{L , j} + {p}_{0 , j} + {\sum }_{n = 1}^{∞} \frac{λ {wE}_{1 n}}{2 DS} {( - 1 )}^{n - 1} ( {q}_{L , j} - \frac{{q}_{L , 0}}{{e}^{{g}_{n} {t}_{j}}} - {\sum }_{t = 1}^{j} {q}_{L , i} \frac{{e}^{{g}_{n} Δ t} - 1}{{e}^{{g}_{n} ( j - i + 1 ) Δ t}} ) , \qquad ( 34 )$$
$${q}_{0 , j} = {q}_{L , j} + \frac{DS π}{λ wL} {\sum }_{n - 1}^{∞} ( 1 - 2 n ) {u}_{n , 0} {e}^{- {g}_{n} {t}_{j}} + \frac{π}{2 L} {\sum }_{n - 1}^{∞} ( 1 - 2 n ) {E}_{1 n} ( {q}_{L , j} - \frac{{q}_{L , 0}}{{e}^{{g}_{n} {t}_{j}}} - {\sum }_{i = 1}^{j} {q}_{L , i} \frac{{e}^{{g}_{n} Δ t} - 1}{{e}^{{g}_{n} ( j - i + 1 ) Δ t}} ) ; \qquad ( 35 )$$
reorganizing Eq. (34) and Eq. (35) as follows:
$$[ \begin{matrix}{p}_{L} \\ {q}_{0}\end{matrix} ] = [ \begin{matrix}{H}_{1} & {H}_{2} \\ {H}_{3} & {H}_{4}\end{matrix} ] [ \begin{matrix}{p}_{0} \\ {q}_{L}\end{matrix} ] + [ \begin{matrix}{γ}_{p} \\ {γ}_{q}\end{matrix} ] , \qquad ( 36 )$$
where p_{L} and p₀ represent a pressure vector at the outlet and inlet of the pipeline, respectively; q_{L} and q₀ represent a flow vector at the outlet and inlet of the pipeline, respectively; H₁ to H₄ represent constant coefficient matrices with the dimension of Nₜ×Nₜ, and γₚ and γ_{q} represent a constant coefficient vector of pressure and mass flow with the dimension of Nₜ×1, respectively, determined by the initial conditions; the elements may be represented as follows:
$$\{ \begin{matrix}{p}_{0} = [ {p}_{0 , 1} , ⋯ , {p}_{0 , Nt} ] , {p}_{L} = [ {p}_{L , 1} , ⋯ , {p}_{L , Nt} ] \\ {q}_{L} = [ {q}_{L , 1} , ⋯ , {q}_{L , Nt} ] , {q}_{0} = [ {q}_{0 , 1} , ⋯ , {q}_{0 , Nt} ]\end{matrix} , \qquad ( 37 )$$
$${γ}_{p , j} = {\sum }_{n = 1}^{∞} ( {u}_{n , 0} + {E}_{1 n} {m}_{0} ) {( - 1 )}^{n - 1} {e}^{- {g}_{n} {t}_{j}} , \qquad ( 38 )$$
$${γ}_{q , j} = \frac{DS π}{λ wL} {\sum }_{n - 1}^{∞} ( 1 - 2 n ) ( {u}_{n , 0} + {E}_{1 n} {m}_{0} ) {e}^{- {g}_{n} {t}_{j}} , \qquad ( 39 )$$
$${H}_{1} = 1 , {H}_{3} = 0 , {{H}_{2. ji}}_{i > j} = {{H}_{4. ji}}_{i > j} = 0 , \qquad ( 40 )$$
$${{H}_{2. ji}}_{i = j} = \frac{λ w}{2 DS} ( {\sum }_{n = 1}^{∞} {{E}_{1 n} ( - 1 )}^{n - 1} {e}^{- {g}_{n} Δ t} - L ) , \qquad ( 41 )$$
$${{H}_{2. ji}}_{( i > j )} = \frac{λ w}{2 DS} ( {\sum }_{n = 1}^{∞} {{E}_{1 n} ( - 1 )}^{n - 1} \frac{1 - {e}^{- {g}_{n} Δ t}}{{e}^{{g}_{n} ( j - i + 1 ) Δ t}} ) , \qquad ( 42 )$$
$${{H}_{4. ji}}_{( i = j )} = \frac{π}{2 L} {\sum }_{n = 1}^{∞} {E}_{1 n} ( 1 - 2 n ) {e}^{- {g}_{n} Δ t} + 1 , \qquad ( 43 )$$
$${{H}_{4. ji}}_{( i > j )} = \frac{π}{2 L} {\sum }_{n = 1}^{∞} {E}_{1 n} ( 1 - 2 n ) \frac{1 - {e}^{- {g}_{n} Δ t}}{{e}^{{g}_{n} ( j - i + 1 ) Δ t}} ; \qquad ( 44 )$$
defining the number of nodes and pipelines in the natural gas system as N_{g} and N_{b}, respectively, and defining an identity matrix and a zero matrix as 1 and 0, respectively; introducing incidence matrices Aᵢₙ, Aₒᵤₜ, A_{nb1}, and A_{nb2} to describe topological properties in the natural gas system, wherein
Aᵢₙ comprises N_{g}×N_{b} sub-matrices for associating flow at end of a branch with flow at a node, and in response to a sub-matrix of an i-th row and j-th column being 1, the flow flows from the end of the branch j into the node i, otherwise, the sub-matrix is 0; Aₒᵤₜ comprises N_{g}×N_{b} sub-matrices for associating flow at head end of a branch with flow at a node, and in response to a sub-matrix of an i-th row and j-th column being 1, the flow flows from the node i into the head end of the branch j, otherwise, the sub-matrix is 0; A_{nb1} comprises N_{b}×N_{g} sub-matrices for associating pressure at end of a branch with pressure at a node, and in response to a sub-matrix of an i-th row and j-th column being 1, pressure at the node j is equal to pressure at the end of the branch i, otherwise, the sub-matrix is 0; A_{nb2} comprises N_{b}×N_{g} sub-matrices for associating pressure at a head end of a branch with pressure at a node, and in response to a sub-matrix of an i-th row and j-th column being 1, pressure at the node j is equal to pressure at the head end of the branch i, otherwise, the sub-matrix is 0; particularly, in response to the node j being a compressor node with a pressure ratio of K_{cp} and the node j being connected to the head end of the branch i, the sub-matrix of the i-th row and jth column is K_{cp}×1;
constructing, based on the incidence matrices, equations of mass conservation at nodes and pressure continuity between nodes and pipelines, expressed as follows:
$${A}_{in} {q}_{L} = {A}_{out} {q}_{0} = qn , \qquad ( 45 )$$
$${p}_{L} = {A}_{nb 1} pn , {p}_{0} = {A}_{nb 2} pn , \qquad ( 46 )$$
where pn and qn represent a pressure and a vector at the node, respectively; p_{L}, p₀, q_{L}, and q₀ are all vectors of Nt×1; the sub-matrices 1 and 0 in coefficient matrices Aᵢₙ, Aₒᵤₜ, A_{nb1}, and Aₒᵤₜ₂ are all Nt×Nt matrices;
substituting Eq. (46) into a first row of Eq. (36) as follows:
$${q}_{L} = {H}_{2}^{- 1} ( ( {A}_{nb 1} - {A}_{nb 2} ) pn - {γ}_{p} ) = {H}_{a 1} pn + {H}_{a 2} , \qquad ( 47 )$$
where Hₐ₁ and Hₐ₂ represent a constant coefficient matrix and a vector describing mass flow at an outlet of a pipeline, respectively; Eq. (46) and Eq. (47) are substituted into a second row of Eq. (36) as follows:
$${q}_{0} = {H}_{4} ( {H}_{a 1} pn + {H}_{a 2} ) + {γ}_{q} = {H}_{{a}_{3}} pn + {H}_{{a}_{4}} , \qquad ( 48 )$$
where Hₐ₃ and Hₐ₄ represent a constant coefficient matrix and a vector describing mass flow at an inlet of the pipeline, respectively; Eq. (47) and Eq. (48) are substituted into Eq. (45) to associate pressure and mass flow at the node as follows:
$$qn = ( {A}_{in} {H}_{a 1} - {A}_{out} {H}_{a 3} ) pn + ( {A}_{in} {H}_{a 2} - {A}_{out} {H}_{a 4} ) = {H}_{a 5} pn + {H}_{a 6} , \qquad ( 49 )$$
where Hₐ₅ and Hₐ₆ are a constant coefficient matrix and a vector describing a relationship between pressure and mass flow at a node, respectively; subscripts sr and ns are defined as a variable identification of a gas source node and a gas load node, respectively, and Eq. (49) is expanded to obtain the natural gas network equivalent model based on the practical analytical expressions:
$$[ \begin{matrix}{qn}_{sr} \\ {qn}_{ns}\end{matrix} ] = [ \begin{matrix}{H}_{a 51} & {H}_{a 52} \\ {H}_{a 53} & {H}_{a 54}\end{matrix} ] [ \begin{matrix}{pn}_{sr} \\ {pn}_{ns}\end{matrix} ] + [ \begin{matrix}{H}_{a 61} \\ {H}_{a 62}\end{matrix} ] , \qquad ( 50 )$$
where Hₐ₅₁, Hₐ₅₂, Hₐ₅₃, and Hₐ₅₄ are sub-matrices in Hₐ₅, and Hₐ₆₁ and Hₐ₆₂ are sub-vectors in Hₐ₆; pnₛᵣ and pnₙₛ are a pressure vector at a source node and a load node, respectively; qnₛᵣ and qnₙₛ are a mass flow vector at the source node and the load node, respectively; the mass flow at the source node and the pressure at the load node in the natural gas system are fully expressed as functions of the boundary conditions using matrix transformation, namely, a simplified method of natural gas network equivalent model is as follows:
$${pn}_{ns} = {H}_{a 54}^{- 1} ( {qn}_{ns} - {H}_{a 53} {pn}_{sr} - {H}_{a 62} ) , \qquad ( 51 )$$
$${qn}_{sr} = {H}_{a 51} {pn}_{sr} + {H}_{a 52} {pn}_{ns} + {H}_{a 61} . \qquad ( 52 )$$
